(19) United States
(12) Patent Application Publication
(10) Pub. No.: US 2003/0167233 A1
(43) Pub. Date: Sep. 4, 2003

(54) Method of sharing manufacturing data with a customer of manufactured parts

(75) Inventor: Douglas H. Smith, Akron, OH (US)

Correspondence Address: POLSTER, LIEDER, WOODRUFF & LUCCHESI, 763 SOUTH NEW BALLAS ROAD, ST. LOUIS, MO, 63141-8750, US

(73) Assignee: The Timken Company

(21) Appl. No.: 09/798,188

(22) Filed: Mar. 2, 2001

(51) Int. Cl. G06G 7/00

(52) U.S. Cl. 705/50

(57) ABSTRACT

A method of sharing manufacturing data with a consumer of a product is disclosed. A unique identifying indicia, such as a serial number or bar code is associated with each manufactured product. That identifying indicia is detected by the consumer of the product, through communication with the manufacturer of the product, preferably via the Internet. The manufacturer maintains a record of both the unique identifying indicia and physical properties of the specific product corresponding to the unique identifying indicia. Upon receiving a request from the consumer of the product, the manufacturer communicates the desired physical properties of the specific product associated with the unique identifying indicia to the consumer. It is therefore possible for the consumer to avoid a step of precision physical measurement of the product, since the actual physical properties have been measured by the manufacturer and recorded previously.

### REFERENCE TO RELATED APPLICATIONS

Not Applicable

### STATEMENT REGARDING FEDERALLY SPONSORED RESEARCH OR DEVELOPMENT

Not Applicable.

### BACKGROUND OF THE INVENTION

Many manufactured products or components of products are considered to be fungibles, that is to say each product or component is virtually identical with the other. In reality, such manufactured products or components are made within certain tolerances, so that the differences between those products are within an acceptable range of measurable physical properties. In many applications, the consumer of a manufactured product is unconcerned with the specific physical properties of that product, so long as the product falls within the specified tolerance levels presented by the manufacturer.

However, in certain applications, a consumer of a manufactured product must make accommodations for even miniscule variations within the manufactured product, regardless of whether or not the product falls within the tolerances presented by the manufacturer. Heretofore, the consumer would resort to physically measuring the manufactured product in order to compensate for variations between an ideal physical property and the actual physical property of the manufactured product. For example, the consumer of antifriction bearings may require the inner diameter of the bearing surface or bore size to be of a particular dimension. That consumer of such an antifriction bearing traditionally would measure the bearing with a precision device, such as a laser micrometer to determine the actual inner diameter, and then select a shaft of specific, pre-measured outer diameter to pair with the bearing to produce a desired interference or loose-fit condition.

The manufacturer of the antifriction bearing may make physical measurements of each product, for quality control or other purposes. Therefore, the manufacturer of the antifriction bearing may have the actual physical properties of each manufactured product produced. However, due to traditional arrangements between suppliers and customers in which a customer purchases a component within a guaranteed tolerance range, the supplier does not make use of any measured component data beyond its own internal quality control practices.

### BRIEF SUMMARY OF THE INVENTION

The present invention relates to communicating physical characteristics of a manufactured product with a consumer of that product. A unique identifying indicia, such as a serial number or bar code is associated with each manufactured product. That identifying indicia is detected by the consumer of the product, and communicated to the manufacturer of the product, preferably via the Internet. The manufacturer maintains a record of both the unique identifying indicia and physical properties of the specific product corresponding to the unique identifying indicia. Upon receiving a request from the consumer of the product, the manufacturer communicates the desired physical properties of the specific product associated with the unique identifying indicia to the consumer. It is therefore possible for the consumer to avoid a step of precision physical measurement of the product, since the actual physical properties have been measured by the manufacturer and recorded previously.

Other uses of the present invention will become apparent to those skilled in the art in light of the following disclosure.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a flowchart of an embodiment of the method of the present invention;

FIG. 2 is a perspective view of an antifriction bearing with an identifying indicia;

FIG. 3 is an alternative embodiment of the method of the present invention.

Corresponding reference characters indicate corresponding parts throughout the several views of the drawings.

### DETAILED DESCRIPTION OF INVENTION

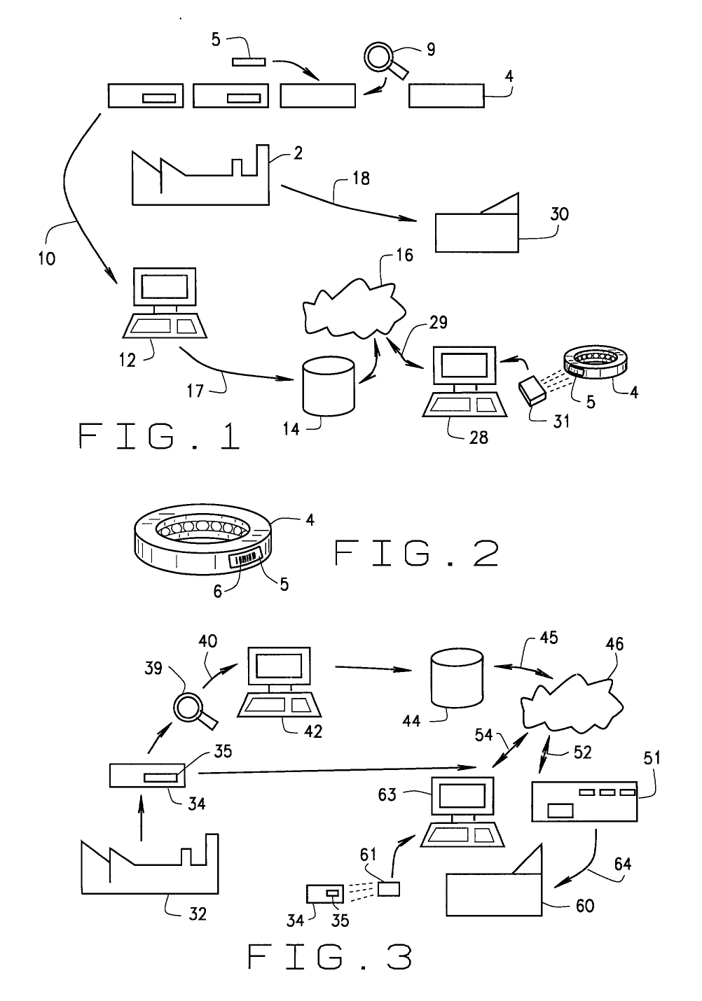

Referring now to FIG. 1, an exemplary method of the present invention has a manufacturer 2 of a manufactured product, and a customer 30 of the manufactured product.

The manufacturer 2 encodes each manufactured product 4 with a unique indicia 5. The unique indicia 5 may be a serial number, a bar code, an emitted energy source such as radio frequency generated from a suitable transmitter, or any other perceptible or detectable device or marking. Of course, the unique indicia 5 is a distinct and exclusive identifier of an individual manufactured product. The unique indicia 5 may be incorporated into the manufactured product contemporaneously with the manufacture of the product, or it may be added after the product is manufactured.

The manufacturer makes at least one measurement 9 of a physical property of the manufactured product 4. In the illustrative example of an antifriction bearing, this measurement may be the actual dimensions of the product, such as bore size, outer diameter, etc., or the actual weight of the product, or a characteristic of the product, such as torque, run-out, etc. These examples are merely illustrative, and one skilled in the art will appreciate many physical characteristics which may be measured.

At least one physical property is measured by the manufacturer and is associated 10 with a unique identifying indicia 5 of the product such that a one to one correlation between the unique identifying indicia 5 representing the measured physical property of the product corresponds to the product 4. Preferably, many physical properties are measured by the manufacturer and are associated 10 with the unique identifying indicia 5 representing the measured physical properties of the product 4 such that a one to many correlation between the unique identifying indicia 5 representing the measured physical properties of the product correspond to the product 4.

The association 10 between the physical property of the product 4 and the unique identifying indicia 5 is recorded. Preferably, the recordation of the physical property and the unique identifying indicia is recorded electronically, and more preferably the electronic recording is stored as data in a software program of a computer 12. When stored as data on a computer, it is preferable that the software program used is a database 14, and more preferably a relational database, such as Oracle®, available from Oracle Corporation, 500 Oracle Parkway Redwood Shores, Calif. 94065 U.S.A. for example. Of course, those skilled in the art will appreciate that other relational databases could be used, such as for example a structured query language (SQL) database, or that spreadsheets or word processing software could be employed for data storage within the intended scope of the present invention. A first communication link 17 brings the database 14 in communication with the manufacturer's computer 12. It is to be understood that a communication link in this regard may be through wires, cables, electromagnetic waves or other acceptable means, or if the database is contained in a storage device within the manufacturer's computer, a suitable internal data bus.

The customer 30 detects the unique identifying indicia 5 on its associated product 4 using a suitable detection device 31. Of course, if the unique identifying indicia 5 is a serial number or other suitable visually perceptible marking, a human observer could replace the detecting device 31. The detected indicia 5 is recorded, preferably on a customer's computer 28. A second communication link 29 brings customer's computer 28 into communication with the stored data 14 by means of the Internet 16. It is to be understood that a communication link in this regard may be through wires, cables, electromagnetic waves or other acceptable means. Additionally, any appropriate network may be utilized in the practice of the present invention, the Internet being an exemplary network.

Now the customer 30 has an actual physical measurement 9 of the product 4, so that any adjustments that might be required to accommodate the product 4 for the customer's needs do not necessitate a measurement on the customer's part, but may be made using shims, spacers, other adjusting methods, or automated manufacturing or assembly processes employed by the customer.

Referring now to FIG. 2, a manufactured product 4 has a unique identifying indicia 5, in this example a bar code 6 affixed, for example by an adhesive. Optionally, the bar code (or other uniquely identifiable feature) 6 is stamped, printed, etched, burned, laser marked, or otherwise associated directly upon the manufactured product 4.

Referring now to FIG. 3, a manufacturer 32 has an automated manufacturing system 33 that fabricates a product 34. Measurement 39 is performed on the product 34 at or immediately after the fabrication of the product 34. A unique identifying indicia 35 is added to the product 34 either during or after the measurement 39 is performed. The measurement 39 of the product 34 and unique identifying indicia 35 are associated 40, and recorded, preferably on a computer 42. The recorded association between the product 34 and the unique identifying indicia 35 is stored in an effective retrieval medium, such as database 44, for example. A first communication link 45 is established for making the association of measurement 39 of the product 34 and unique identifying indicia 35 available to a remote source such as a wide area network (WAN) 46. In this alternative embodiment of the present invention, the manufacturer 32 transfers the product 34 with associated unique identifying indicia 35 to the supplier 51. In this alternative embodiment of the present invention, the manufacturer 32 transfers the product 34 with associated unique identifying indicia 35 to the supplier 51. In this embodiment of the present invention, the database 44 is made available to an intermediate supplier 51 for communication of the physical properties of a manufactured product by way of the Internet 46, using a second communications link 52. This allows the supplier 51 to obtain statistical data for use in forecasting future requirements, for example.

The supplier 51 then transfers 54 the product 34 to the customer 60. The transfer 22 may be due to an order from the customer 30, or due to an automatic shipping order pursuant to an agreement, or based upon another cause triggering a shipment to be made.

A suitable detection device 61 detects the unique identifying indicia 35 associated with the product 34. The detected unique identifying indicia 35 is recorded or routed to a customer's computer 63. When the unique identifying indicia 35 is routed to a customer's computer 63, the method of routing may be manual, or may be automatically accomplished through a link between detection device 61 and customer's computer 63. A third communication link 54 is established between the customer's computer 63 and the WAN 46, for accessing the physical measurement 39 associated with the product 34.

Now the customer 60 has an actual physical measurement 39 of the product 34, so that any adjustments that might be required to accommodate the product 34 for the customer's requirements do not necessitate a measurement on the customer's part, but may be made using shims, spacers, other adjusting methods, or assembly or manufacturing methods.

It is contemplated in the present invention that a secure system for protecting data may be employed, and that a monetary fee may be required of either the supplier 51, the customer 30 or both, for access to the associated data 40 of the manufactured product 34. In this regard, the secure system may employ the secure sockets layer (SSL) protocol, or any other suitable security measure for protection of the data from unauthorized use. In the preferred embodiment, the prospective user of the data would be prompted for and required to enter a password for access to the data. In this regard, a partially accessible manufacturer intranet (extranet) may be used as a way of sharing the manufacturer's data with a customer or supplier.

It is to be understood that many variations within the intended scope of the present invention exist, and the two illustrative flow charts of FIG. 1 and FIG. 3 are not intended to be limiting.

Numerous variations will occur to those skilled in the art in light of the foregoing disclosure. For example, the unique identifying indicia may also be used to detect counterfeit products, or for inventory control, and in this regard, a second, proprietary indicia may be encoded with the unique identifying indicia. While a peer to peer computer network is preferred, a peer to host, host to host or other network may be employed. While a relational database is preferred, a flat file database, or any other software capable of retrieving information from a group of information may be used within the intended scope of the present invention. These are merely illustrative.

Having thus described the invention, what is claimed and desired to be secured by Letters Patent is:

1. A method of sharing manufacturing data with a customer of manufactured products comprising:
providing a manufactured product, said manufactured product having at least one unique identifying indicia such that the identifying indicia corresponds to said manufactured product in a one to one correlation;
measuring at least one physical property associated with said manufactured product;
associating said at least one physical property of said manufactured product with said unique identifying indicia;
recording said physical property and said unique identifying indicia; and
providing a communication medium for dissemination of said physical property based upon the correlation of said unique identifying indicia with said physical property.

2. The method of claim 1 wherein said measured physical property is a dimension.

3. The method of claim 1 further comprising storing said recorded physical property in a storage medium.

4. The method of claim 3 wherein said communication medium establishes a link between a manufacturer and the Internet.

5. The method of claim 1 wherein a consumer of said product establishes a link to said recorded physical property.

6. The method of claim 3 wherein a consumer of said product establishes a link to said stored, recorded physical property.

7. The method of claim 4 wherein a consumer establishes a second communication link to the Internet.

8. The method of claim 7 wherein said consumer establishes a secure link to the Internet, for access to said recorded physical property of said product.

9. The method of claim 8 wherein said recorded physical property is stored in a storage medium accessible by way of the Internet.

10. The method of claim 8 wherein said consumer is required to enter a password for access to said recorded physical property of said product.

11. The method of claim 1 wherein said product is transferred to an intermediate supplier.

12. The method of claim 1 wherein said product is transferred to a consumer.

13. The method of claim 11 wherein said unique identifying indicia is detected by said intermediate supplier through a suitable detection device.

14. The method of claim 12 wherein said unique identifying indicia is detected by said consumer through a suitable detection device.

15. The method of claim 10 wherein a fee is charged to said consumer for access to said recorded physical property.

16. The method of claim 1 wherein a second, proprietary indicia is further encoded with said unique identifying indicia, such that said second, proprietary indicia provides security against counterfeit products.
